(19) United States
(12) Patent Application Publication
(10) Pub. No.: US 2016/0327209 A1
(43) Pub. Date: Nov. 10, 2016

(54) HYDROGEN STORAGE TANK COMPRISING METAL HYDRIDES WITH HEAT EXCHANGES

(71) Applicants: COMMISSARIAT À L'ÉNERGIE ATOMIQUE ET ÉNERGIES ALTERNATIVES, Paris (FR); MCPHY ENERGY, La Motte Fanjas (FR)

(72) Inventors: Olivier GILLIA, Olivier (FR); Albin CHAISE, Sassenage (FR); David VEMPAIRE, Claix (FR); Laurent PEYREAUD, Oriol en Royans (FR)

(73) Assignee: COMMISSARIAT A L"ENERGIE ATOMIQUE ET AUX ENERGIES AL TERNATIVES, Paris (FR)

(21) Appl. No.: 15/105,399

(22) PCT Filed: Dec. 16, 2014
(86) PCT No.: PCT/EP14/78064

§ 371 Date: Jun. 16, 2016

(30) Foreign Application Priority Data
Dec. 17, 2013 (FR) 13 62782

(51) Int. Cl. F17C 11/00

(52) U.S. Cl. CPC F17C 11/005; F17C 2201/0104; F17C 2221/012; F17C 2227/03

(57) ABSTRACT

A tank for hydrogen storage by absorption in a hydrogen storage material includes a shell with a longitudinal axis closed off at its two longitudinal ends, a hydrogen supply and outlet for released hydrogen, and at least one heat transfer element installed transversally in the shell and in contact with the inner surface of the shell. The heat transfer element has an outer peripheral edge formed from tabs in elastic contact with the inner surface of the shell such that contact between the heat transfer element and the shell is maintained during temperature variations during the hydrogen charge and discharge phases. The heat transfer element is designed to provide heat transfers from and to the storage material that will be contained in the tank.

### TECHNICAL FIELD AND PRIOR ART

This invention relates to a hydrogen storage tank with metal hydrides and a hydrogen storage system comprising at least one such tank.

Attempts are being made to find alternative energies to oil, particularly due to the depletion of oil reserves. One promising vector for these energy sources is hydrogen that can be used in fuel cells to generate electricity.

Hydrogen is an element that is very widespread throughout the universe and on the earth, and it can be generated from natural gas or other hydrocarbons, but also by simple electrolysis of water for example using electricity generated by solar or wind energy.

Hydrogen cells are already used in some applications, for example in some automobile vehicles but they are not yet widespread, particularly due to precautions that have to be taken and difficulties with the storage of hydrogen.

Hydrogen can be stored in compressed form at between 350 and 700 bars, which creates problems with safety and energy consumption for gas compression. Tanks then have to be capable of resisting these pressures, knowing particularly that shocks can be applied to these tanks when they are installed in vehicles.

It can be stored in liquid form, although the storage efficiency of this type of storage is low and it cannot be used for storage over long periods. The change in the volume of hydrogen as it changes from the liquid state to the gas state under normal pressure and temperature conditions increases its volume by a factor of about 800. Tanks for the storage of hydrogen in liquid form are usually not very resistant to mechanical shocks, which creates severe safety problems.

There is also a system for “solid” storage of hydrogen in the form of hydride. This storage allows high storage capacity and makes use of a moderate hydrogen pressure, while minimising the energy impact of the storage on the global efficiency of the hydrogen chain, i.e. from its production to its conversion to another energy.

The principle of solid storage of hydrogen in hydride form is that some materials and particularly some metals have the capability of absorbing hydrogen to form hydride, this reaction is called absorption. The hydride formed can then restore gaseous hydrogen and a metal. This reaction is called desorption.

Absorption and desorption take place as a function of the partial pressure of hydrogen and the temperature.

Absorption and desorption of hydrogen on a powder or a metal matrix M take place according to the following reaction:

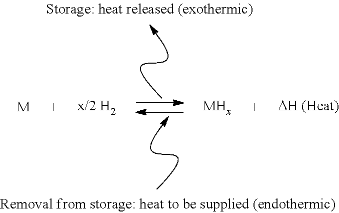

where M is the powder or the metal matrix;
and MHₓ is the metal hydride.

For example, a metal powder cart be used that is brought into contact with hydrogen, an absorption phenomenon occurs and a metal hydride is formed. Hydrogen is released in a desorption mechanism.

Hydrogen storage is an exothermic reaction, i.e. that releases heat, while the release of hydrogen is an endothermic reaction, i.e. that absorbs heat.

Furthermore, the volume of the material increases as it absorbs hydrogen.

When the material absorbs hydrogen, there is a release of heat, the equilibrium pressure, in other words the pressure above which the material absorbs hydrogen, increases and it quickly reaches the hydrogen supply pressure, thus effectively blocking the hydriding reaction. The material has to be cooled to overcome this phenomenon that hinders fast charging of the tank. Conversely, when releasing hydrogen, heat has to be added in order to increase the equilibrium pressure and to have a pressure source higher than the pressure required at the outlet from the tank. Means then have to be provided to enable heat exchanges between the material inside the tank and a heat sink or a heat source, both for the charge and the discharge phases.

Document U.S. Pat. No. 4,667,815 discloses a metal hydride storage system comprising a cylindrically shaped tank in which boxes containing hydride are superposed. Each box comprises an upper part provided with an outer flange surrounding a setback part of a lower part, this flange being in contact with the inner surface of the tank, thus providing heat exchange between the inside and the outside.

It is desirable to have good contact between the boxes and the tank to achieve good heat conduction through the tank.

Good thermal contact between the shell and the boxes cannot be guaranteed, due firstly to differential expansion between the shell material and the box material, and secondly to geometric defects.

### Presentation of the Invention

Consequently, one purpose of this invention is to provide a hydrogen storage system in which heat exchanges are improved.

The above-mentioned purpose is achieved by a storage system comprising a tank with a longitudinal axis configured t hold the storage material and heat transfer elements installed in the tank and in contact with the inside of the tank. The storage material is placed in the tank so as to exchange heat with the heat transfer elements.

The elements comprise an outer peripheral edge bearing elastically in contact with the inner face of the tank such that contact between the heat transfer elements and the tank is achieved despite differential expansion and/or geometric defects, and heat transfers between the conducting elements and the shell are maintained.

Elasticity of the peripheral edge compensates for geometric variations between the tank and the heat transfer elements, which maintains heat transfers throughout charge and discharge cycles.

Advantageously, the heat transfer element(s) comprise(s) a central zone and the peripheral edge comprises a plurality of tabs bent relative to this central zone, the tabs providing contact with the wall of the tank and deforming about their bending axis.

Advantageously the central zone and the tabs are made in a single piece.

Very advantageously, the central zone may comprise radial cutouts which gives greater flexibility to the heat transfer element and enables the heat transfer element to have a greater deformation capability.

The subject-matter of the invention is then a tank for hydrogen storage by absorption in a hydrogen storage material, comprising a shell with a longitudinal axis closed off at its two longitudinal ends, a hydrogen supply and outlet for released hydrogen and at least one heat transfer element installed transversally in the shell and in contact with the inner surface of the shell, said heat transfer element having an outer peripheral edge in elastic contact with the inner surface of the shell such that contact between the heat transfer element and the shell is maintained during temperature variations during the hydrogen charge and discharge phases, said heat transfer element being designed to provide heat transfers from and to the storage material that will be contained in the tank.

In one advantageous example, the heat transfer element comprises an approximately falt central zone and the peripheral edge comprises tabs surrounding the central zone, said tabs forming an angle with the central zone.

Preferably, the tabs are made in a single piece with the central zone and are bent relative to the central zone.

For example, the shell has an approximately circular cross-section and the heat transfer element has an approximately circular shape, a dimension between a base of the tabs connected to the central zone and a free end of the tabs being equal to between 0.5% and 75% of the inside radius of the shell.

The heat transfer element may comprise at least one through hole.

The heat transfer element may comprise a plurality of through holes comprising means that can allow hydrogen to pass while preventing passage of the storage material in powder form.

The tank may comprise at least one conduit extending along the longitudinal axis in the shell and passing through the heat transfer element through said through hole. The through hole in the heat transfer element may advantageously be surrounded by tabs in elastic contact with the conduit. The through hole is advantageously located at the centre of the central zone in which the heat transfer element comprises radial cutouts starting from the through hole.

The tank advantageously comprises means capable of allowing hydrogen to pass and preventing the passage of storage material in powder form located between at least the tabs of the peripheral edge and/or the tabs of the through hole.

In one example embodiment, the heat transfer element may comprise radial cutouts extending from the peripheral edge and that do not open up in the central hole.

In one advantageous example, the tank comprises at least one container located on the heat transfer element, said container being designed to contain the hydrogen storage material. A gap may be provided between the container and the inner surface of the shell.

In one example embodiment, the bottom of the container is formed by the heat transfer element.

The tank may advantageously include a heat conducting structure added into the container.

The tank may comprise several heat transfer elements, pairs of which delimit a compartment that will contain heat storage material.

Preferably, the container is placed in contact between two heat transfer elements.

A heat management system may advantageously be provided in contact with the outside of the shell.

The tank may comprise a storage material in powder form, the heat transfer elements being embedded in the powder or a storage material in powder form contained in at least one container or a storage material in pellet form, arranged in contact between two heat transfer elements, hydrogen diffusion elements possibly being provided in contact with the pellets.

### BRIEF DESCRIPTION OF THE DRAWINGS

This invention will be better understood after reading the following description and the appended drawings in which:

FIGS. 1A, 1B and 1C are top, side and perspective views respectively of a heat transfer element according to the invention,

FIG. 1D is a longitudinal sectional view of a part of the element in FIG. 1A,

FIGS. 2A to 2E are diagrammatic views of examples of an assembly device using heat transfer elements in FIGS. 1A to 1C,

FIGS. 3A and 3B are top and perspective views respectively of another example embodiment of a heat transfer element according to the invention,

FIG. 3C is a sectional view of the element in FIGS. 3A and 3B along plane AA in a first deformation state and in a second deformation state;

FIGS. 4A to 4C are different views of another example embodiment of a storage system using heat transfer elements according to the invention.

### DETAILED PRESENTATION OF PARTICULAR EMBODIMENTS

Metal hydrides will be referred to as “storage material” throughout the remainder of the description.

A <<hydriding cycle>> is an absorption phase followed by a hydrogen desorption phase.

Throughout the following description, the disclosed tank(s) has (have) a cylindrical shape of revolution, which is the preferred embodiment. Nevertheless, any tank formed from hollow elements with a longitudinal dimension greater than its transverse dimension and with an arbitrary cross-section, for example polygonal or ellipsoidal, is not outside the scope of this invention.

A hydrogen storage system according to the invention comprises one or several tanks containing storage material and a heat management system designed to add and remove heat to release and store hydrogen respectively in the storage material.

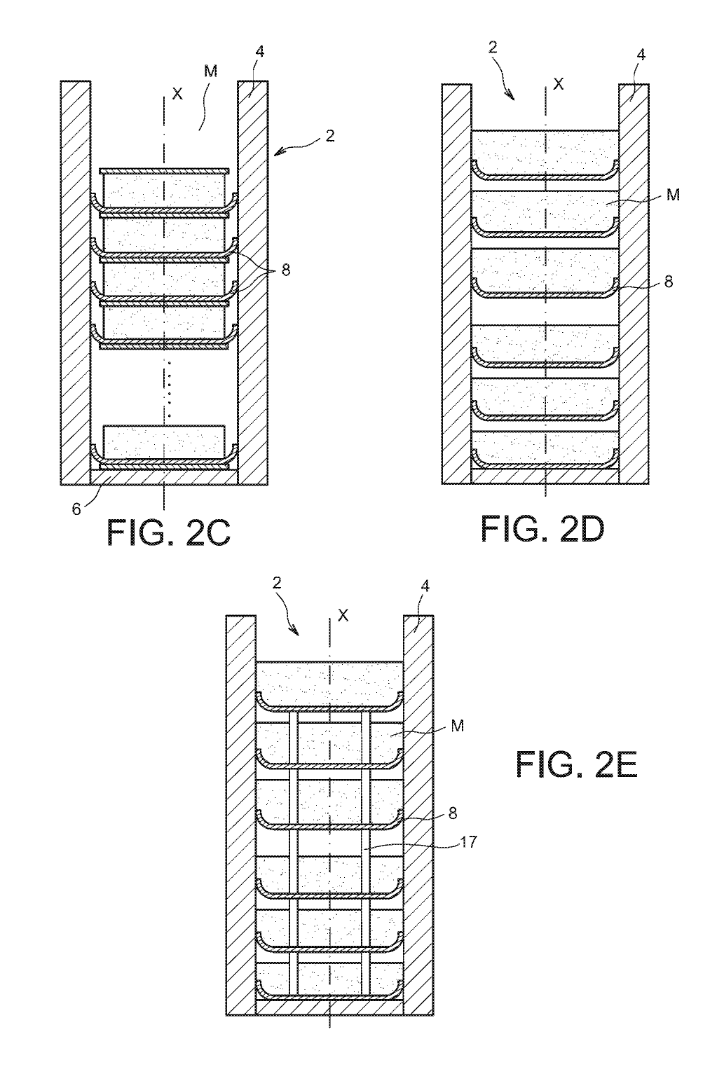

FIGS. 2A to 2C show diagrammatic views of storage material tanks.

The tank 2 comprises a shell 4 with a longitudinal axis X closed off at a lower end by a bottom 6. The tank also comprises a top (not shown) closing the upper end of the shell 4. In the example shown, the shell 4 is circular in cross-section.

The tank is usually oriented such that the longitudinal axis X is approximately in line with the direction of the gravity vector. However, its orientation can change during use, particularly in the case of onboard use.

The tank comprises means (not shown) of supplying hydrogen and collecting hydrogen.

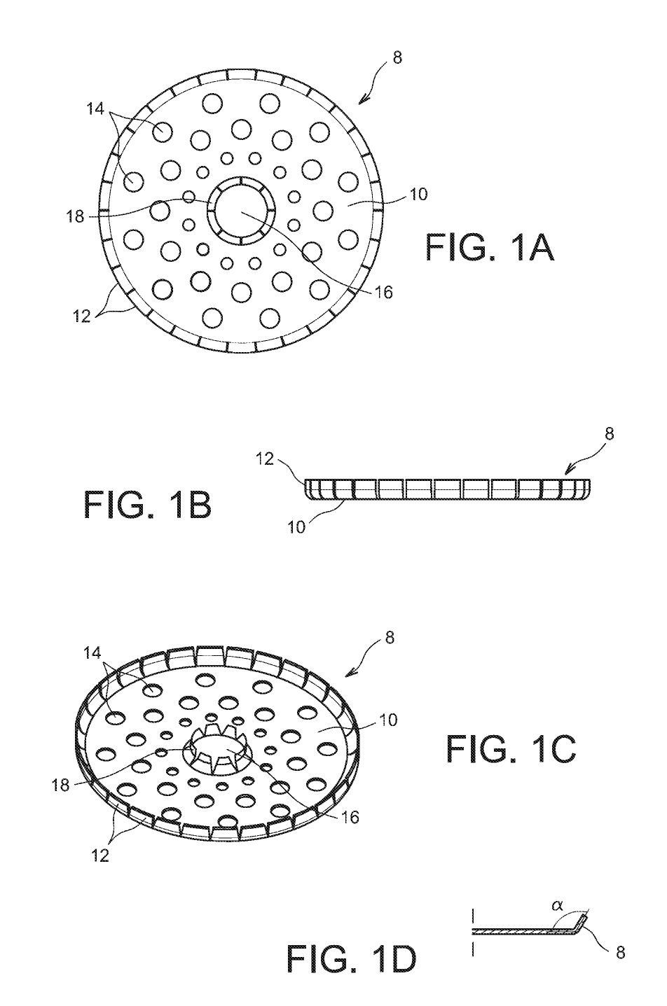

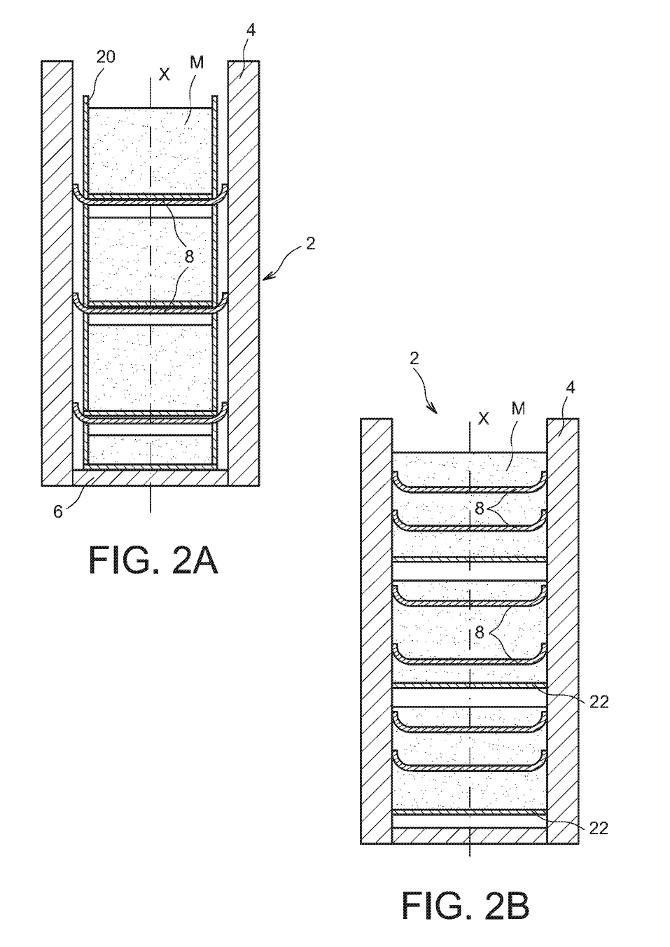

The tank also comprises heat transfer elements 8 installed inside the shell 4. An example embodiment of one of these heat transfer elements is shown in FIGS. 1A to 1C. These means assure heat conduction transversally between the storage material M and the shell.

The heat transfer element 8 is approximately in the shape of a flat-bottomed circular cup comprising a central zone 10 and provided with tabs 12 on its radially outer periphery, that are inclined relative to the plane of the central zone 10. The tabs 12 are advantageously made in a single piece with the central zone 10, by cutting and bending.

The tabs may be approximately plane or they may be curved, and if they are curved, the contact between the tabs and the shell takes place tangentially, and is then larger than it is for plane tabs for which contact with the shell is linear.

In the example shown in FIG. 1D, the angle α between the tabs and the central zone 10 is equal to or greater than 900.

During assembly of the heat transfer element in the shell, the tabs 12 are elastically deformed radially inwards. A small plastic strain may occur, but contact will always be made by the elastic return part of the tabs.

The heat transfer elements 8 are made from a material that has good thermal conductivity relative to the storage material, and preferably very good thermal conductivity such as copper or aluminium. Preferably, the thermal conductivity of the material used for the heat transfer element is at least ten times more than that of the storage material.

For example, the distance between the end of the tabs 12 fixed to the central zone 10 and their free end is between a few percent and a few tens of percent of the inside diameter of the shell, for example between 0.5% and 75% of the inside diameter of the shell, and for example 10%. Thus, they have a sufficient area in contact with the inner surface of the shell 4 to conduct heat.

The dimensions of the heat transfer elements 8 are chosen such that they can be installed in the shell and so that the tabs are elastically deformed. Preferably, the peripheral diameter of the tabs is slightly greater than the inside diameter of the shell, so as to achieve good thermal contact between the elements 8 and the shell.

For example, the diameter of heat transfer elements around the periphery of the tabs may be 1 to 2 mm more than the inside diameter of the shell. This value may depend on the geometric defect measured on the shell.

Preferably, the value of the diameter φ₁ around the periphery of the tabs is determined at the yield stress of the material of heat transfer elements 8 when it is equal to the average diameter of the shell after installation. This value of the diameter φ₁ is increased by the difference between this diameter and the largest diameter of the shell, φ₁-φ_{max shell}, so as to make contact with all tabs since the shell is not perfectly circular. It would be possible to choose an even larger diameter and in this case the tabs will be more deformed in the plastic field.

During the assembly of heat transfer elements 8 in the shell 4, the tabs 12 deform mainly elastically but some plastic strain can also take place. Residual elasticity assures permanent contact between each tab and the inner wall of the shell.

The thickness of the heat transfer elements is chosen as a function of the target application, since hydrogen charging and discharging rates may be different. The thickness of the heat transfer element is selected as a function of the heat flux to be removed by conduction. For example, heat transfer elements may be of the order of 1 mm thick.

FIG. 2A diagrammatically shows heat transfer elements 8 installed in the shell 4. The heat transfer elements 8 are held in the shell 4 by radial elastic deformation of tabs 12.

The heat transfer elements delimit compartments for the storage material.

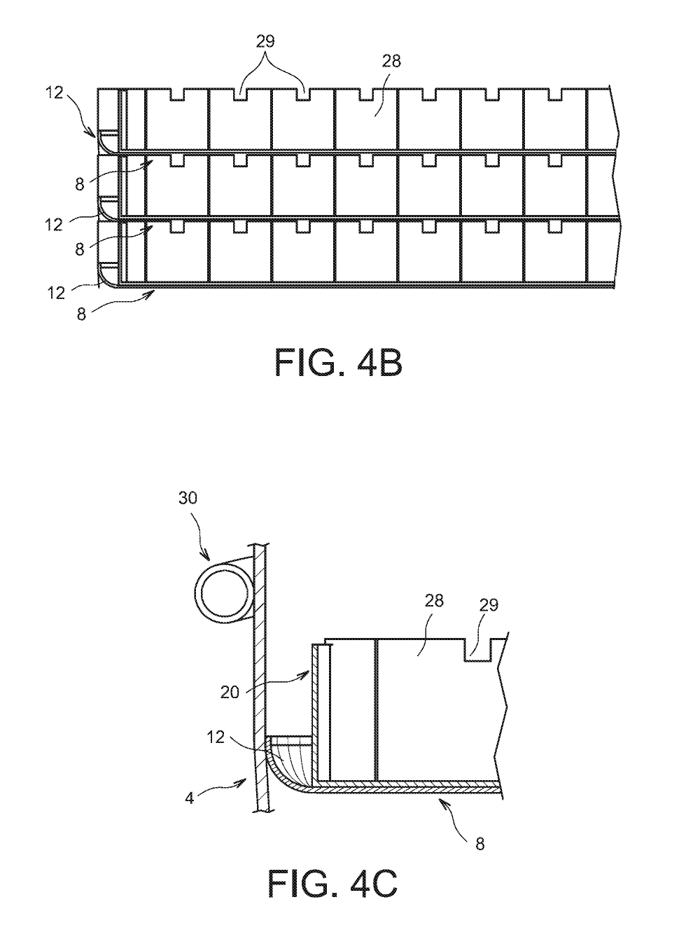

Contact stresses between the heat transfer elements and the shell may be sufficient so that the heat transfer elements support the storage material. Alternately, as will be disclosed in more detail below, the material is supported by superposed buckets 20, the elements 8 being inserted between the buckets (FIGS. 2A and 4B). As a variant, each stage is supported on the powder of the stage underneath it (FIG. 2C).

This material may be in different forms. It may be in the form of pellets formed from a hydride compacted with other materials, for example hydride may be mixed with carbon, to achieve cohesion of the pellets and to improve heat conduction. These pellets maintain their general shape during hydriding cycles (FIG. 2C).

The storage material may be in the form of a loose powder, the storage system then being filled with powder directly (FIG. 2A or 2B).

The storage material may be in the form of solid cakes or ingots or more generally polyhedron shaped pieces with dimensions of a few millimeters or centimeters. The material in these various forms simplifies filling. The material tends to swell as it absorbs hydrogen during hydriding cycles. The inherently heterogeneous swelling of the material causes fragmentation into a powder, those skilled in the art also use the term decrepitation. This case corresponds to the examples in FIGS. 2A and 2B.

In the example in FIGS. 1A to 1C, the heat transfer element comprises holes 14 distributed in the central zone 10 through which hydrogen is allowed to passe from one compartment to the other during charge and discharge phases. These holes 14 may have the same cross-section or a different cross-section. If the storage material is in powder or cake form that will decrepitate, the holes 14 are closed off by means that allow the passage of hydrogen but prevent the passage of powder. These means may for example consist of a fine grating, fabric, a porous sintered material or even a filter made from an organic material or a polymer, with the only constraint that neither the hydrogen storage material nor the hydrogen itself should be polluted under the temperature and pressure conditions at which the hydride material is used. In the example shown, the holes have different cross-sections, the radially outermost holes having a larger cross-section. The holes may have a constant cross-section. The total cross-section of holes is determined as a function of the hydrogen flow that has to pass through them.

For example, the means of preventing the passage of powder through the holes are selected so as to prevent the passage of fine hydride particles, between 1 μm and 5 μm for example in the case of LaNi5 type hydride.

Hydrogen may also pass around the periphery of the heat transfer elements 8, between the tabs, particularly in the example embodiments in figures in FIGS. 2A and 2C.

In the example shown, the central zone of the heat transfer element comprises a central passage 16 around which there are tabs 18 oriented towards the axis of the heat transfer element.

For example, this central passage 16 may be used for passage of a conduit not shown) for the flow of a heat transporting fluid bringing heat in or taking heat out depending on the step in the hydriding cycle. Tabs 18 are elastically deformed by the tube, good contact is then achieved also giving good heat transfer between the conduit and heat transfer elements. Tabs 18 in elastic contact with the conduit also at least partially close off the gap between the conduit and the edge of the through hole and thus at least partly prevent powder from dropping in the lower compartment.

Advantageously, a filter element like that described above can be envisaged to prevent the hydride material in powder form from passing through the interstices between the tabs 12 or 18 without preventing the passage of hydrogen. For example, it would be possible to place a fine filtration grating above the tabs supporting the hydride material.

Alternately, this through hole 16 can be used for the passage of a hydrogen supply and collection conduit. The conduit may for example be made from a porous material, for example it may be made from Poral® or it may be perforated with through holes, and connected to a hydrogen supply and collection circuit; the size of holes in the tube is sufficiently small to prevent the passage of powder. For example, a conduit made of porous material calibrated on a size of 1 can be used to be impermeable to hydride powder and to allow hydrogen to pass through.

In this case, the tabs 18 are not required because there is no need for heat exchanges between the heat transfer elements and the hydrogen supply and collection conduit. Nevertheless, as mentioned above, the tabs 18 in elastic contact with the conduit can partially close of the gap between the conduit and the edge of the through hole and thus at least partly prevent powder from dropping in the lower compartment.

Several through holes may be provided for the passage of several conduits, it would be possible to have one or several heat transporting fluid circulation conduits and/or one or several hydrogen supply and collection conduits.

We will now describe various examples of tanks comprising heat transfer elements according to the invention.

In FIG. 2A, the storage material M in powder form in each compartment is received in a container supported on a heat transfer element. The container is such that its side wall is not in contact with the shell, leaving a lateral gap between the shell and the container, thus preventing any force from being applied on the shell when the storage material swells. This lateral gap also allows hydrogen to pass through.

This container 20 retains the powder and prevents it from coming into contact with the wall of the shell and also provides heat conduction by contact with the heat transfer element. Containers are stacked, with the lower containers supporting the upper containers.

The containers may for example be made of stainless steel, copper, or aluminium. As a variant, it would be possible for the side wall of the container to be made of a plastic material and for the bottom of the container to be formed directly by the element 8. The powder storage material M is then in direct contact with the element 8 which gives good heat transfer between the material and the element, while using a plastic material to partly retain the powder.

Advantageously, the container 20 of a compartment is in contact through its upper end with the heat transfer element 8 of the upper compartment 20. The heat transfer element 8 of the upper compartment forms a lid limiting leakage of the powder through the top of the container and this contact also enables heat exchange. Thus, in this advantageous embodiment, heat exchanges take place at the lower part of the container and at the upper part of the container.

In FIG. 2B, the storage material in powder form is in direct contact with the shell. In this example embodiment, the height of the powder bed is chosen to be less than the diameter of the powder bed so that the mechanical pressure applied by the powder on the shell can be ignored relative to the pressure applied by hydrogen.

In this example embodiment, stages are made in the tank by installing transverse plates 22, and heat transfer elements 8 according to the invention are placed within the thickness of the powder. In the example shown, the heat transfer elements 8 are embedded in the powder, each heat transfer element then makes heat exchanges with the powder through its lower face and its upper face. In this example, each heat transfer element is subjected to a mechanical pressure from the powder on its two faces. Elements 8 can slide along the axis of the shell as the material swells as it is being charged. The elements can slide in the shell in each charge/discharge phase, or can reach an approximately fixed position depending on stresses between the elements and the shell. Advantageously, a means of retaining powder and allowing hydrogen to pass through may be designed to prevent powder from passing through the elements 8 at the holes 14 and at the interstices between the tabs 12 and the shell, and between the tabs 18 and the conduit.

In FIG. 2C, the storage material M is in pellet form. Each pellet is placed on a heat transfer element. In the example shown and advantageously, each pellet is in contact through its lower face and its upper face with a heat transfer element increasing heat exchanges and assuring homogeneous heat exchanges in each pellet.

In this example, plates made of a porous material are located in the porous material perpendicular to the longitudinal axis, improving hydrogen diffusion. Pellets are dense and their porosity is low. The porous plates distribute hydrogen everywhere above the pellet to minimise the diffusion length of hydrogen in the pellet.

FIG. 2D shows a preferred example embodiment of the invention in which the heat transfer elements 8 also form support elements for the powder storage material M. Elements are located in zones between the tabs and possibly at holes 14 and the passage 16 if they are provided, so as to allow hydrogen to pass and to retain the powder storage material, preventing it from accumulating in the bottom of the tank. A free volume V is provided between the top of the powder and the bottom of the upper heat transfer element in order to enable free swelling of the storage material in the charge phase and to prevent interaction between the powder and the upper heat exchange element. In this example, elements 8 are held in place in the shell by friction.

FIG. 2E shows a variant of the tank in FIG. 2D, in which spacers 17 are advantageously provided between the heat transfer elements 8 so that they are positioned correctly relative to each other in the long term. For example, after a shock or if a tank is dropped, it is possible that one or several elements 8 will slide upwards along the shell. The spacers may for example be formed from small columns, for example fixed to the bottom of elements 8. As a variant, the small columns may be supported by a single ring as is shown diagrammatically in FIG. 2E.

The space between the elements is maintained by these spacers.

It is particularly useful to use these spacers in the case of a tank with a large number of stages.

FIGS. 4A to 4C show an example practical embodiment of a storage tank according to the invention, comprising a plurality of heat transfer elements 8 each delimiting a stage. Each stage comprises a container 20 supported on a heat transfer element 8. The container is such that the hydride forms a thin bed, i.e. with low diameter to height ratio. Furthermore, the containers are designed so that they are not in mechanical contact with the shell.

In the example shown and advantageously, each container 20 comprises a box structure 28 delimiting sub-compartments in the containers improving heat transfers in the thickness of the hydride bed and preventing the hydride bed from flowing laterally if the tank is inclined during manipulations. The sub-compartments are square or rectangular in the example shown, but it would be possible for them to be arranged for example in a honeycomb.

Advantageously and as shown in FIGS. 4B and 4C, notches 29 are made in the free edges of boxes to facilitate the passage of hydrogen. These notches are not shown in FIG. 4A for reasons of clarity.

The tank also comprises a heat management system comprising a pipe 30 wound around the outside surface of the shell 4 in which a heat transporting fluid will circulate to bring heat in or to remove heat depending on the phase of the cycle. According to one advantageous embodiment, it would be possible to immerse the shell 4 in a bath of liquid heat transporting fluid.

Very advantageously, the bottom of the container could be formed directly by the heat transfer element, further improving transfers between the powder and the heat transfer element.

For example, the tank could have the following characteristics:
the heat transfer elements are made of copper and are 2 mm thick;
the heat transfer elements are 10 mm high;
the diameter of the shell is 300 mm;
the hydride bed is 20 mm thick;
the pitch of the inserted structure is more than 20 mm.

We will now disclose an example embodiment of the heat transfer elements.

During a first step, the heat transfer elements are made by cutting out from a plate made for example of copper or aluminium.

Tabs are cut out in the next step. As a variant, this step can be done at the same time as the first step. Material may also be removed to prevent tabs from overlapping when they are bent.

The tabs 12 are bent in a next step such that they are inclined slightly outwards and delimit an outer radius larger than the outside radius of the central portion 10.

If the heat transfer elements contain holes, these holes will be made for example using a punch, and using several punches if the holes have different cross-sectional dimensions. The holes are preferably made before the tabs are bent.

If the through hole 16 is surrounded by tabs 18, the tabs may be made as described for the tabs 12. Material is not removed for the tabs 18.

Therefore, it is very easy to make heat transfer elements with a low cost price.

The tank is made as follows.

A first heat transfer element 8 is force fitted into the shell 4, the tabs 12 facing upwards. The tabs 12 bend radially inwards mainly elastically. The heat transfer element 8 is moved longitudinally inside the shell until it reaches the required position.

Due to the residual elasticity, the heat transfer element 8 is held in position in the shell 4 and the tabs 12 are in contact with the inner surface of the shell 4.

The storage material M is then placed, in the form of a powder, cake or pellet. A container 20 may be provided to contain the powder, depending on the form of the material. As a variant, the internal structure of the tank containing the material M will be made and the assembly will then be inserted into the shell.

A second heat transfer element 8 is force fitted into the shell 4 and is moved until it reaches the required position, for example in contact with the previously installed pellet.

The steps mentioned above are repeated as many times as necessary.

The tank is then closed and connections are made to the hydrogen supply and collection circuit and to the heat management system.

If one or several conduits extend longitudinally in the shell, they are installed before the heat transfer elements are installed. Heat transfer elements are provided with through holes. Conduits pass through the heat transfer elements when the elements are installed in the shell.

We will now explain the operation of the heat transfer elements.

As shown in FIGS. 4A and 4C, the heat management system may for example be formed by a tube 30 wound around the tank, in which a heat transporting fluid circulates, this heat transporting fluid extracting heat or bringing heat in by heat exchange with the shell.

Alternately, the heat management system is formed by a heat transporting fluid bath inside which the tank is placed, or a liner that surrounds the tank.

In a hydriding phase, i.e. when charging with hydrogen, hydrogen is supplied to the tank. Hydrogen is brought in through a porous conduit that passes through the different compartments, or circulates between the shell 4 and the heat transfer elements 8 between the tabs 12 and/or through the holes 14 formed in the heat transfer elements 8.

Absorption of hydrogen by the storage material causes heat generation. This heat must be removed so as to not slow or even stop hydriding. Heat is extracted outwards through the heat transfer elements 8 due to the presence of heat transfer elements 8 through the tabs 12 and their permanent contact with the shell 4. Heat can also pass radially without passing through the heat transfer elements, for example if the height of the material M is large compared with the diameter of material M.

Even if the coefficient of expansion of heat transfer elements 8 is more than that of the shell 4, this differential is absorbed by elastic deformation of peripheral tabs 12. Since strain includes an elastic part, the contact can be maintained in the long term during operation of the hydrogen tank in absorption/desorption cycles.

During the dehydrating or discharge phase, the hydrogen reaction requires a heat input. Heat is then brought in by heat transfer elements 8 in contact with the shell 4 that itself is heated by the heat transporting fluid.

This invention also has the advantage that it can overcome circularity and diameter defects in the shell. Cost prices of tubes made of sheet metalwork are still attractive but these tubes do not usually have good geometric precision. The elastic deformation provided by the tabs maintains thermal contact for a given shell circularity and diameter defect.

It will be understood that tank characteristics can vary depending on the applications, according to an application specification, particularly concerning tank charge and discharge rates.

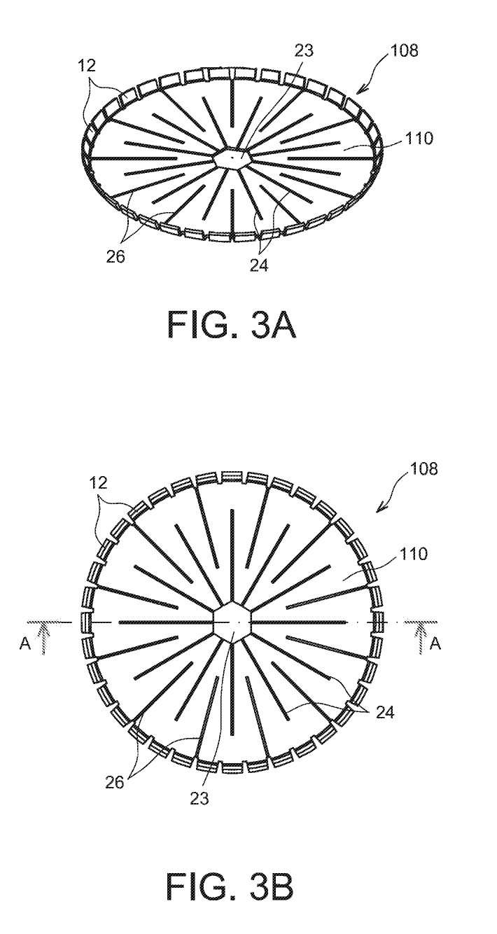

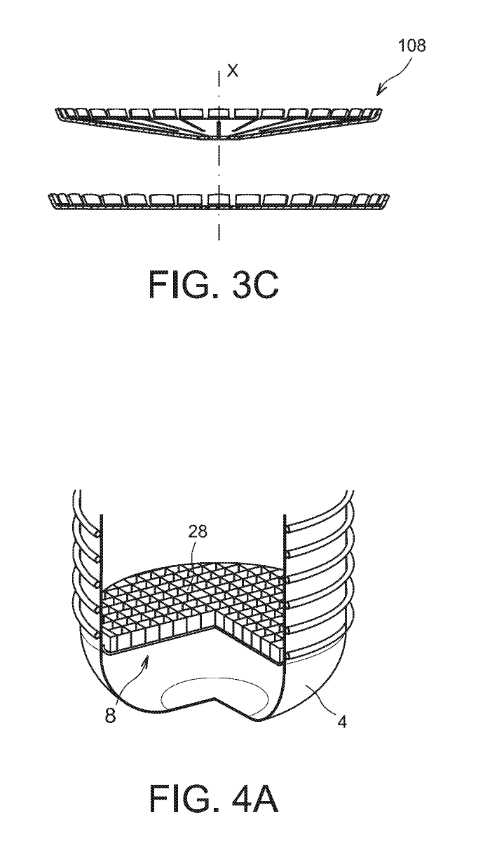

FIGS. 3A to 3C show another example embodiment of a heat transfer element 108 comprising a central orifice 23 and first radial cutouts 24 extending from the central orifice on part of the radius of the central zone 110 and second radial cutouts 26 extending from the radially outer edge towards the central orifice 23 and extending on part of the radius.

Preferably the cutouts extend approximately radially.

Preferably, the first and second cutouts 24, 26 are distributed at uniform angles around the central orifice.

The second radial cutouts are made between the tabs. It is also planned that a second radial cutout will be made between two first radial cutouts.

An element that only includes cutouts 24 or cutouts 26 will not go outside the scope of this invention.

For example, the angle between two cutouts 24 or two cutouts 26 is between 5° and 70°.

The cutouts are straight in the example shown. They could be in any other shape.

In the example shown, the central hole is polygonal in shape. As a variant the hole could be round.

As a variant, tabs could be provided around the central hole. These are then oriented in the direction opposite the outer fins, downwards in the example shown, so that the inner and outer tabs move apart at the same time.

The heat transfer element thus manufactured is more flexible. The outside diameter of the heat transfer element can be varied, making use of a wide elastic deformation range. The amplitude of this variation is much larger than can be obtained with the heat transfer element shown in FIGS. 1A to 1C.

One advantageous assembly method for this type of heat transfer element is to install them making use of their improved elasticity to compensate for the assembly gaps between the fins and the shell. The standard assembly thus means that the elements type 108 must have a conical configuration, as shown in the upper part of FIG. 3C. The elastic strain amplitude is then higher than it is for type 8 elements. This amplitude is materialised by the large difference in diameter between the configuration of element 108 (upper part in FIG. 3C), and the flattened rest configuration (lower part in FIG. 3C). When assembling the stack, the element 108 is flattened between two pellets, which causes an increase in the outer diameter of the element 108 that results in contact of the tabs with the wall of the shell. The contact thus has a larger reserve of elastic deformation than the case of elements 8. This type of installation makes it possible to have only slight contact during assembly (during insertion into the shell), which facilitates assembly because there is less friction between the tabs and the walls.

Therefore, this heat transfer element can be adapted to variations in the shell diameter. It will be understood that the view of the shell is diagrammatic and is only given for illustration purposes.

For example, heat transfer elements in FIGS. 3A to 3C made of 2 mm thick aluminium with an outside diameter of 300 mm can be adapted to a shell with an inside diameter of between 299 mm and 301 mm.

This example embodiment has the advantage that it can overcome geometric defects due to its larger reserve of elastic deformation. The cutouts actually create larger circumferential elastic deformability.

As for the holes, a means can be placed in the cutouts and preferably above the holes to prevent powder from dropping into the lower compartment, for example this means may be a grating, fabric or Poral.

These cutouts can also be used to allow the passage of hydrogen, distribution of the cutouts advantageously supplying and collecting hydrogen uniformly.

The central hole can be used for the passage of a heat transporting fluid conduit or a hydrogen supply/collection conduit.

The system according to this invention may be used to transport hydrogen, for onboard storage of hydrogen for a fuel cell or a thermal combustion engine, for stationary storage of hydrogen.

Therefore, the system can be used as an onboard tank for transport means such as boats, submarines, cars, buses, lorries, site machinery, motor cycles, for example to provide a fuel cell or a thermal combustion engine. It can also be used for transportable energy power supplies such as batteries for portable electronic equipment such as portable telephones, computers, etc.

The system according to this invention may also be used as a stationary storage system for a larger quantity of energy, such as electricity generating sets, for storage of hydrogen produced in large quantities by electrolysis with electricity originating from wind turbines, photovoltaic cells, geothermal, etc.

Any other hydrogen source for example originating from reforming hydrocarbons or other methods of obtaining hydrogen (photo-catalysis, biological, geological, etc. can also be stored.

1-22. (canceled)

23. A tank for hydrogen storage by absorption in a hydrogen storage material, comprising:
a shell with a longitudinal axis closed off at its two longitudinal ends;
a hydrogen supply and outlet for released hydrogen; and
at least one heat transfer element installed transversally in the shell and in contact with the inner surface of the shell, said heat transfer element having an outer peripheral edge in elastic contact with the inner surface of the shell such that contact between the heat transfer element and the shell is maintained during temperature variations during the hydrogen charge and discharge phases, said heat transfer element being configured to provide heat transfers from and to the storage material that will be contained in the tank.

24. The tank according to claim 23, in which the at least one heat transfer element comprises an approximately flat central zone and the peripheral edge comprises tabs surrounding the central zone, said tabs forming an angle with the central zone.

25. The tank according to claim 24, in which the tabs are made in a single piece with the central zone and are bent relative to the central zone.

26. The tank according to claim 24, in which the shell has an approximately circular cross-section and the at least one heat transfer element has an approximately circular shape, a dimension between a base of the tabs connected to the central zone and a free end of the tabs being equal to between 0.5% and 75% of an inside radius of the shell.

27. The tank according to claim 23, in which the at least one heat transfer element comprises at least one through hole.

28. The tank according to claim 27, in which the at least one heat transfer element comprises a plurality of through holes comprising elements configured to allow hydrogen to pass while preventing passage of the storage material in powder form.

29. The tank according to claim 27, comprising at least one conduit extending along the longitudinal axis in the shell and passing through the at least one heat transfer element through said through hole.

30. The tank according to claim 29, in which the through hole of the at least one heat transfer element is surrounded by tabs in elastic contact with the conduit.

31. The tank according to claim 27, in which the through hole is located at the centre of the central zone in which the at least one heat transfer element comprises radial cutouts starting from the through hole.

32. The tank according to claim 24, comprising a device configured to allow hydrogen to pass and preventing the passage of storage material in powder form located between at least the tabs of the peripheral edge and/or the tabs of the through hole.

33. The tank according to claim 27, in which the at least one heat transfer element comprises radial cutouts extending from a peripheral edge and that do not open up in the central hole.

34. The tank according to claim 23, in which the at least one heat transfer element delimits a compartment, said the at least one heat transfer element supporting the heat storage material.

35. The tank according to claim 34, comprising at least one container located on the at least one heat transfer element, said at least one container being configured to contain the hydrogen storage material.

36. The tank according to claim 35, in which a gap is provided between the at least one container and an inner surface of the shell.

37. The tank according to claim 35, in which the bottom of the at least one container is formed by the at least one heat transfer element.

38. The tank according to claim 35, comprising a heat conducting structure added into the at least one container.

39. The tank according to claim 34, in which the at least one heat transfer element comprises several heat transfer elements, delimiting a pair of compartments that will contain hydrogen storage material.

40. The tank according to claim 39, comprising at least one container configured to contain the hydrogen storage material placed in contact between two heat transfer elements.

41. The tank according to claim 23, comprising a heat management system in contact with the outside of the shell.

42. The tank according to claim 23, comprising a storage material in powder form, the at least one heat transfer element being embedded in the powder.

43. The tank according to claim 35, comprising a storage material in powder form contained in at least one container.

44. The tank according to claim 23, in which the at least one heat transfer element comprises several heat transfer element and in which the tank comprises a storage material in pellet form arranged in contact between two heat transfer elements, hydrogen diffusion elements possibly being provided in contact with the pellets.
